(19) United States
(12) Patent Application Publication
(10) Pub. No.: US 2013/0201511 A1
(43) Pub. Date: Aug. 8, 2013

(54) IMAGE PROCESSING APPARATUS, OPERATION STANDARDIZATION METHOD, AND NON-TRANSITORY COMPUTER-READABLE RECORDING MEDIUM ENCODED WITH OPERATION STANDARDIZATION PROGRAM

(71) Applicants: Keisuke TERAMOTO, Itami-shi (JP); Masami YAMADA, Sennan-gun (JP); Atsushi OHSHIMA, Amagasaki-shi (JP); Daisuke SAKIYAMA, Kawanishi-shi (JP); Atsushi TAMURA, Amagasaki-shi (JP); Yukina HISADA, Toyokawa-shi (JP)

(72) Inventors: Keisuke TERAMOTO, Itami-shi (JP); Masami YAMADA, Sennan-gun (JP); Atsushi OHSHIMA, Amagasaki-shi (JP); Daisuke SAKIYAMA, Kawanishi-shi (JP); Atsushi TAMURA, Amagasaki-shi (JP); Yukina HISADA, Toyokawa-shi (JP)

(73) Assignee: Konica Minolta Business Technologies, Inc., Chiyoda-ku (JP)

(21) Appl. No.: 13/759,108

(22) Filed: Feb. 5, 2013

(30) Foreign Application Priority Data
Feb. 6, 2012 (JP) 2012-023557

(51) Int. Cl. H04N 1/00

(52) U.S. Cl. CPC H04N 1/00384
USPC 358/1.13

(57) ABSTRACT

An image processing apparatus includes an operating portion to output operation identification information in response to acceptance of an operation designated by an operation user, an application portion operative, in response to reception of one of process identification information items, to perform a process of the type corresponding to the received process identification information item, an association portion operative, at the stage when an application program is installed, to associate a plurality of types of processes determined by the application program respectively with sets of one or more operations among a plurality of types of operations, a process specifying portion to specify a process associated with the set of one or more operations specified by the operation identification information item(s) output from the operating portion, and an operation notification portion to output the process identification information of the specified process to the application portion.

This application is based on Japanese Patent Application No. 2012-023557 filed with Japan Patent Office on Feb. 6, 2012, the entire content of which is hereby incorporated by reference.

### BACKGROUND OF THE INVENTION

1. Field of the Invention

The present invention relates to an image processing apparatus, an operation standardization method, and a non-transitory computer-readable recording medium encoded with an operation standardization program. More particularly, the present invention relates to an image processing apparatus to which an application program is installed, an operation standardization method executed in the image processing apparatus, and a non-transitory computer-readable recording medium encoded with an operation standardization program for causing a computer to execute the operation standardization method.

2. Description of the Related Art

Some recent image processing apparatuses, typified by multi-function peripherals (MFPs), allow application programs to be installed therein. A user can customize an MFP by installing therein an application program according to the type of usage.

On the other hand, there are cases where operation keys are added to an MFP of a new model as a new function is added thereto through product development. This means that MFPs may have different types of keyboards depending on their models. Thus, to cope with the different types of MFPs, application programs have been developed for the respective types of MFPs. Further, various application programs have been developed, and there are cases where the keyboard included in an MFP does not have a certain operation key required for execution of an application program. In such a case, in order to accept an operation corresponding to the operation key lacking in the keyboard, it was necessary for the application program to describe, for example, a process of displaying an image of a new operation key and accepting a user operation of designating the image of the new operation key by using a touch panel.

Japanese Patent Laid-Open No. 2006-079357 discloses a printer which has an application execution portion for executing a print application program and which performs predetermined information processing according to an operation instruction from a user. The printer includes: a touch panel type display portion; a keyboard having a plurality of operation keys; and a display/input control portion which acquires information about the operation keys included in the keyboard and information about the operation keys necessary for execution of the print application program, and, on the basis of the acquired information, causes the display portion to display an image representing any operation key that is not included in the keyboard, among the operation keys necessary for execution of the print application program. This conventional printer is capable of executing a print application program even if one or more of the operation keys necessary for execution of the print application program are not included in the keyboard.

When the number of operation keys not included in the keyboard exceeds the number of images displayed on the display portion, however, the conventional printer may not be able to cope with this problem. Further, in the case where a certain operation key necessary for execution of the print application program is not included in the keyboard, even if one or more of the operation keys included in the keyboard are not in use, the image representing the operation key not included in the keyboard is displayed. In such a case, one or more of the operation keys on the keyboard are not used, hindering effective use of the keyboard.

### SUMMARY OF THE INVENTION

An aspect of the present invention provides an image processing apparatus which includes an operation accepting portion to accept an operation designated by an operation user from among a plurality of types of operations, and a control portion to control the operation accepting portion, wherein the control portion includes: an operating portion operative, in response to acceptance by the operation accepting portion of the operation designated by the operation user, to output operation identification information for identifying the designated operation; an application portion operative, in response to reception of one of a plurality of process identification information items for respectively identifying a plurality of types of processes determined by an application program, to perform a process of the type that corresponds to the received process identification information item among the plurality of types of processes; an association portion operative, at the stage when the application program is installed, to associate, for the application program, a respective one of the plurality of types of processes determined by the application program with a set of one or more operations among the plurality of types of operations; a process specifying portion operative, in response to output by the operating portion of one or more operation identification information items, to specify a process among the plurality of types of processes that has been associated with a set of one or more operations specified by the output operation identification information item(s), for the application program, by the association portion; and an operation notification portion to output the process identification information of the specified process to the application portion.

Another aspect of the present invention provides an operation standardization method performed by a computer, the computer controlling an image processing apparatus including an operation accepting portion for accepting an operation designated by an operation user from among a plurality of types of operations, the computer including an operating portion operative, in response to acceptance by the operation accepting portion of the operation designated by the operation user, to output operation identification information for identifying the designated operation, and an application portion operative, in response to reception of one of a plurality of process identification information items for respectively identifying a plurality of types of processes determined by an application program, to perform a process of the type that corresponds to the received process identification information item among the plurality of types of processes, wherein the method causes the computer to execute: an association step of, at the stage when the application program is installed, associating, for the application program, a respective one of the plurality of types of processes determined by the application program with a set of one or more operations among the plurality of types of operations; a process specifying step of, in response to output by the operating portion of one or more operation identification information items, specifying a process among the plurality of types of processes that has been associated with a set of one or more operations specified by the output operation identification information item(s), in the association step, for the application program; and an operation notification step of outputting the process identification information of the specified process to the application portion.

A further aspect of the present invention provides a non-transitory computer-readable recording medium encoded with an operation standardization program performed by a computer, the computer controlling an image processing apparatus including an operation accepting portion for accepting an operation designated by an operation user from among a plurality of types of operations, the computer including an operating portion operative, in response to acceptance by the operation accepting portion of the operation designated by the operation user, to output operation identification information for identifying the designated operation, and an application portion operative, in response to reception of one of a plurality of process identification information items for respectively identifying a plurality of types of processes determined by an application program, to perform a process of the type that corresponds to the received process identification information item among the plurality of types of processes, wherein the program causes the computer to execute: an association step of, at the stage when the application program is installed, associating, for the application program, a respective one of the plurality of types of processes determined by the application program with a set of one or more operations among the plurality of types of operations; a process specifying step of, in response to output by the operating portion of one or more operation identification information items, specifying a process among the plurality of types of processes that has been associated with a set of one or more operations specified by the output operation identification information item(s), in the association step, for the application program; and an operation notification step of outputting the process identification information of the specified process to the application portion.

The foregoing and other features, aspects, and advantages of the present invention will become more apparent from the following detailed description of the present invention when taken in conjunction with the accompanying drawings.

### BRIEF DESCRIPTION OF THE DRAWINGS

FIG. 1 is a perspective view of an MFP according to an embodiment of the present invention;

FIG. 2 is a block diagram schematically showing the hardware configuration of the MFP;

FIG. 3 is a plan view of an operation panel;

FIG. 4 shows an example of the software architecture of a CPU;

FIG. 5 is a block diagram showing, by way of example, the functions of a CPU included in the MFP, together with data stored in a HDD;

FIG. 6 shows a first example of a master table;

FIG. 7 shows a first example of a first conversion table;

FIG. 8 shows a first example of a second conversion table;

FIG. 9 is a flowchart illustrating an example of the flow of a conversion table generating process;

FIG. 10 is a flowchart illustrating an example of the flow of an operation notification process;

FIG. 11 shows soft keys by way of example;

FIG. 12 is a plan view of an operation panel in another MFP;

FIG. 13 shows a second example of the master table;

FIG. 14 shows a second example of the first conversion table; and

FIG. 15 shows a second example of the second conversion table.

### DESCRIPTION OF THE PREFERRED EMBODIMENTS

The preferred embodiments of the present invention will be described below in conjunction with the drawings. In the following description, the same or corresponding parts are denoted by the same reference characters. Their names and functions are also the same. Thus, a detailed description thereof will not be repeated.

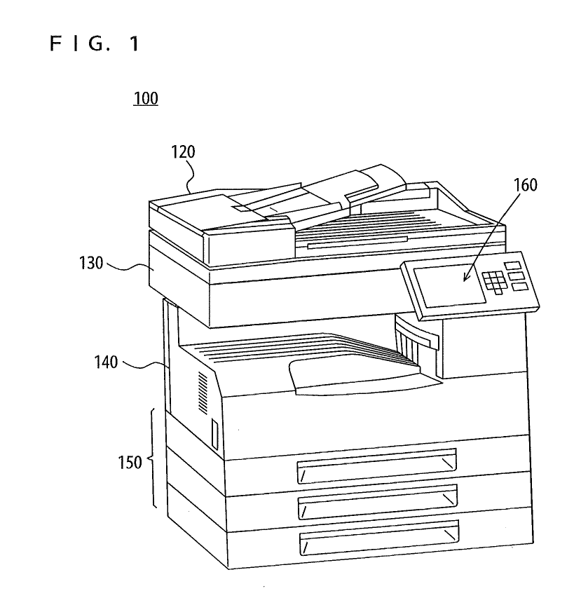

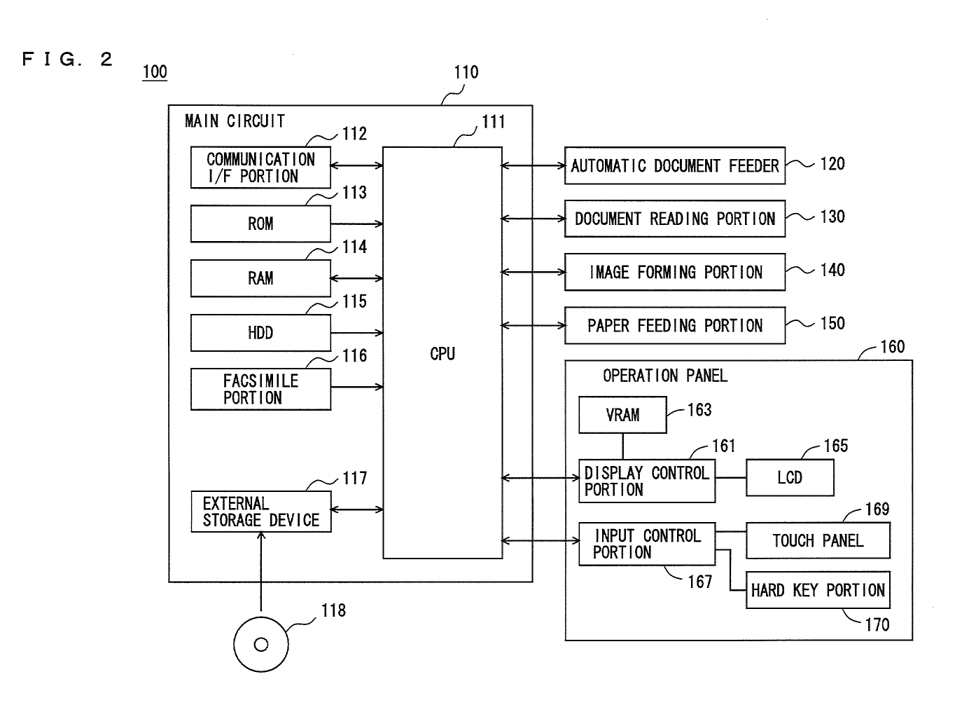

FIG. 1 is a perspective view of an MFP according to an embodiment of the present invention. FIG. 2 is a block diagram schematically showing the hardware configuration of the MFP. Referring to FIGS. 1 and 2, a multi-function peripheral (MFP) 100 serving as an image processing apparatus includes: a main circuit 110; a document reading portion 130 for reading a document; an automatic document feeder 120 for feeding a document to document reading portion 130; an image forming portion 140 for forming an image on a sheet of paper or the like on the basis of image data which is output from document reading portion 130 that has read a document; a paper feeding portion 150 for feeding a sheet of paper to image forming portion 140; and an operation panel 160 serving as a user interface.

Main circuit 110 includes: a central processing unit (CPU) 111; a communication interface (I/F) portion 112; a read only memory (ROM) 113; a random access memory (RAM) 114; a hard disk drive (HDD) 115 as a mass storage; a facsimile portion 116; and an external storage device 117. CPU 111 is connected with automatic document feeder 120, document reading portion 130, image forming portion 140, paper feeding portion 150, and operation panel 160, and is responsible for overall control of MFP 100.

Automatic document feeder 120 automatically feeds a plurality of documents set on a document feed tray, one by one, to a predetermined document reading position set on a platen glass of document reading portion 130, and outputs the document, the image of which has been read by document reading portion 130, onto a document output tray. Document reading portion 130 includes an optical source which irradiates a document placed on the document reading position with light and a photoelectric conversion element which receives light reflected from the document, and scans a document image having a size corresponding to that of the document. The photoelectric conversion element converts the received light into image data made up of electric signals, and outputs the image data to image forming portion 140. Paper feeding portion 150 feeds a sheet of paper, stored in a paper feed tray, to image forming portion 140.

Image forming portion 140 forms an image using well-known electrophotography. Image forming portion 140 performs various kinds of data processing such as shading compensation on image data received from document reading portion 130 and, on the basis of the processed image data, or on the basis of externally received image data, forms an image on a sheet of paper fed by paper feeding portion 150.

Facsimile portion 116 is connected to public switched telephone networks (PSTN), and transmits facsimile data to or receives facsimile data from the PSTN. Facsimile portion 116 stores the received facsimile data in HDD 115. Alternatively, facsimile portion 116 converts the data into print data which can be printed in image forming portion 140, and outputs the same to image forming portion 140, thereby causing image forming portion 140 to form an image on a sheet of paper on the basis of the facsimile data received by facsimile portion 116. Further, facsimile portion 116 converts the data stored in HDD 115 to facsimile data, and transmits the same to a facsimile machine connected to the PSTN.

Communication I/F portion 112 is an interface for connecting MFP 100 to a network. Communication I/F portion 112 communicates with another computer or image processing apparatus connected to the network, using a communication protocol such as the transmission control protocol (TCP) or the file transfer protocol (FTP). The network to which communication I/F portion 112 is connected is a local area network (LAN). It may be connected in a wired or wireless manner. The network is not necessarily the LAN; it may be a wide area network (WAN), public switched telephone networks (PSTN), the Internet, or the like.

ROM 113 stores a program to be executed by CPU 111 or data necessary for execution of the program. RAM 114 is used as a work area when CPU 111 executes a program. Further, RAM 114 temporarily stores read images continuously transmitted from document reading portion 130.

Operation panel 160 includes: a liquid crystal display (LCD) 165; a display control portion 161 which controls display on LCD 165; a video RAM (VRAM) 163; a touch panel 169; a hard key portion 170; and an input control portion 167 which controls touch panel 169 and hard key portion 170. LCD 165 and hard key portion 170 are arranged on an upper surface of MFP 100.

Display control portion 161 is connected to CPU 111, VRAM 163, and LCD 165. VRAM 163 is used as a work area of display control portion 161, and temporarily stores an image to be displayed on LCD 165. Display control portion 161, under the control of CPU 111, controls LCD 165 to cause LCD 165 to display the image stored in VRAM 163. Display control portion 161 causes LCD 165 to display an operation screen which will be described later.

Hard key portion 170 includes a plurality of hard keys. The hard keys, which are contact switches, are connected to input control portion 167. Each hard key, when depressed by an operation user, closes its contact to close a circuit connected to input control portion 167. Each hard key closes the circuit while being depressed by an operation user who operates MFP 100, whereas it opens the circuit while not being depressed by the operation user.

Touch panel 169 is disposed on an upper or lower surface of LCD 165, and outputs the coordinates of a position pushed by the operation user to input control portion 167. Touch panel 169 detects the position designated by the operation user with his/her finger or a stylus pen, and outputs the coordinates of the detected position to input control portion 167. Touch panel 169 preferably has a size equal to or greater than that of the display surface of LCD 165. As touch panel 169 is disposed on the surface of LCD 165, when the operation user designates a position on the display surface of LCD 165, touch panel 169 outputs the coordinates of the position that the operation user has designated on the display surface of LCD 165, to input control portion 167. The touch panel may be, for example, of a resistive type, a surface acoustic wave type, an infrared ray type, an electromagnetic induction type, or a capacitance type, although it is not limited to these types.

If there is any hard key that closed the circuit in hard key portion 170, input control portion 167 outputs identification information for identifying the hard key that closed the circuit, to CPU 111. When touch panel 169 detects a position designated by the operation user, input control portion 167 outputs the coordinates that are output from touch panel 169, as position information indicating the position on the display surface of LCD 165, to CPU 111.

External storage device 117, which is controlled by CPU 111, is mounted with a compact disc read-only memory (CD-ROM) 118 or a semiconductor memory. CPU 111 is capable of accessing CD-ROM 118 via external storage device 117. CPU 111 loads the program recorded on CD-ROM 118 mounted on external storage device 117, into RAM 114 for execution. It is noted that the program executed by CPU 111 is not restricted to the program recorded on CD-ROM 118. CPU 111 may load a program stored in HDD 115, into RAM 114 for execution. In this case, another computer that is connected to a network may rewrite the program stored in HDD 115 of MFP 100, or additionally write a new program therein, via the network to which communication I/F portion 112 is connected. Further, MFP 100 may download a program from another computer connected to the network, and store the program in HDD 115. As used herein, the “program” includes, not only the program which CPU 111 can execute directly, but also a source program, a compressed program, an encrypted program, and so on.

It is noted that the medium for storing a program executed by CPU 111 is not restricted to CD-ROM 118. It may be an optical disc (magneto-optical (MO) disc, mini disc (MD), digital versatile disc (DVD)), an IC card, an optical card, or a semiconductor memory such as a mask ROM, an erasable programmable ROM (EPROM), an electrically erasable and programmable ROM (EEPROM), or the like.

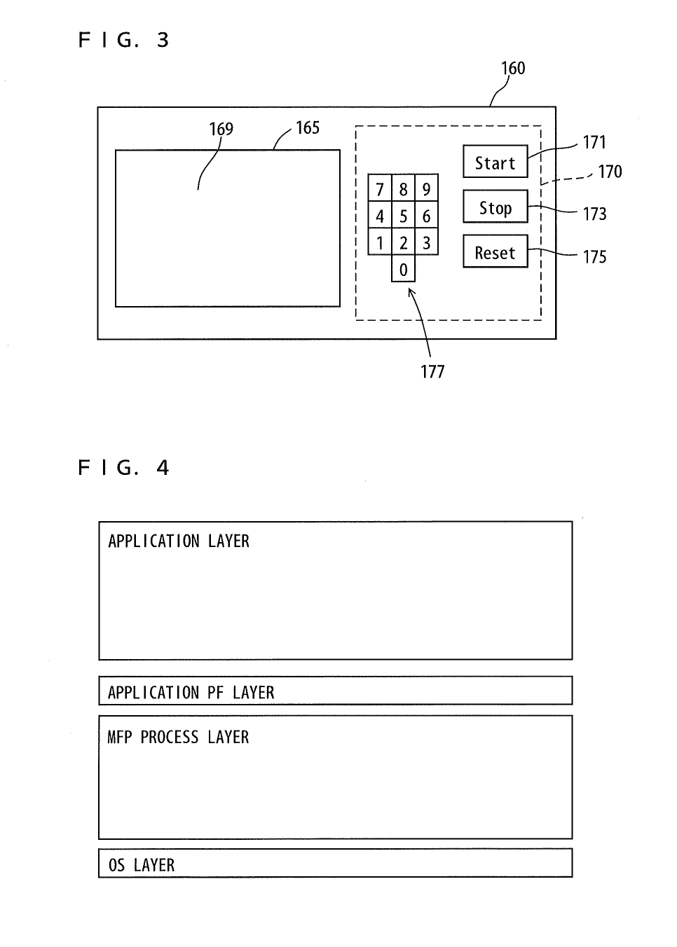

FIG. 3 is a plan view of operation panel 160. Referring to FIG. 3, operation panel 160 includes LCD 165, touch panel 169 which is disposed on a surface of LCD 165, and hard key portion 170 to the right of LCD 165. Hard key portion 170 includes a start key 171 having the key identification information “Start”, a stop key 173 having the key identification information “Stop”, a reset key 175 having the key identification information “Reset”, and a numerical keypad 177 composed of ten keys. Numerical keypad 177 includes ten numerical keys respectively having the key identification information “0” to “9”.

FIG. 4 shows an example of the software architecture of the CPU. Referring to FIG. 4, in CPU 111, an operating system (OS) layer is formed as the bottom layer, and an MFP process layer is formed above the OS layer. Above the MFP process layer, an application platform (PF) layer is formed, and an application layer is formed above the application PF layer.

A task for CPU 111 to execute an OS program belongs to the OS layer. The task belonging to the OS layer performs the process of controlling hardware resources of MFP 100. Here, the hardware resources include communication I/F portion 112, ROM 113, RAM 114, HDD 115, facsimile portion 116, external storage device 117, automatic document feeder 120, document reading portion 130, image forming portion 140, paper feeding portion 150, display control portion 161, and input control portion 167. The task belonging to the OS layer controls the hardware resources in accordance with an operating command input from the MFP process layer. Further, the OS layer shares, with the MFP process layer, operation identification information items for respectively identifying a plurality of types of operations that can be accepted by input control portion 167. When input control portion 167 detects an operation performed by an operation user, the task belonging to the OS layer outputs the operation identification information item for identifying the detected operation, to the MFP process layer.

A task for CPU 111 to execute an application program belongs to the application layer. In the case where two or more application programs are installed into MFP 100, two or more tasks for executing the respective application programs may belong to the application layer. The application programs include programs for customizing a user interface and the like so as to cause MFP 100 to perform the copying process, scanning process, printing process, facsimile transmitting/receiving process, data transmitting/receiving process, and so on. It is noted that the application programs are not restricted to the above-described programs; it may be another application program.

The task for executing an application program performs a plurality of types of processes determined by the application program. The plurality of types of processes include a process of causing a task belonging to the MFP process layer to perform a process to be performed in the MFP process layer. In the case of causing the task belonging to the MFP process layer to perform a process, the task for executing the application program outputs an application command. The application command is a command which has been released as an application program interface (API).

Further, the task for executing the application program specifies a process to be performed, from among the plurality of types of processes determined by the application program, on the basis of an instruction from the operation user who operates MFP 100. The task for executing the application program then performs the specified process. The instruction from the operation user operating MFP 100 is accepted in the OS layer when the operation user inputs the instruction by operating touch panel 169 and/or hard key portion 170. In the present embodiment, the application PF layer is in charge of specifying one of the plurality of types of processes that is to be performed by the task for executing the application program, on the basis of an instruction from the operation user. Therefore, the application program shares, with the application PF layer, process identification information items for respectively identifying the plurality of types of processes determined by the application program. When the task for executing the application program receives a process identification information item from a task belonging to the application PF layer, the task for executing the application program performs the process corresponding to the process identification information item, among the plurality of types of processes.

The application PF layer, located between the application layer and the MFP process layer, has belonging thereto a task for arbitrating a plurality of tasks belonging to the application layer and also controlling the application commands output from the plurality of tasks belonging to the application layer. More specifically, the application PF layer brings one of the tasks belonging to the application layer into a currently selected state in which data can be input/output. The application PF layer accepts an application command output from the task brought into the currently selected state among the tasks belonging to the application layer, and outputs process identification information input from a task belonging to the MFP process layer, to the task in the currently selected state. Further, the task belonging to the application PF layer converts the application commands, output from the respective tasks belonging to the application layer, in accordance with a predetermined rule, for standardization, and outputs the resultant commands to the MFP process layer. This can address the case where a plurality of application programs are different in version, or the like. The application command output from the application PF layer to the MFP process layer may or may not be the same as the application command output from the application layer. Further, the application command output from the application PF layer to the MFP process layer may or may not be released.

When a task belonging to the application PF layer receives operation identification information from the OS layer via the MFP process layer, the task belonging to the application PF layer specifies the process to be performed by the task in the currently selected state among the tasks belonging to the application layer, and outputs the process identification information for identifying the specified process, to the task in the currently selected state.

The MFP process layer, located between the application PF layer and the OS layer, has belonging thereto a task for CPU 111 to execute an MFP process program. The MFP process layer has belonging thereto a task for converting an application command output from a task belonging to the application PF layer, into an operating command which can be interpreted by a task belonging to the OS layer, and outputting the operating command to the task belonging to the OS layer. While an application command is actually converted into one or more operating commands which can be executed by a task belonging to the OS layer, for the convenience sake, it is here assumed that one application command is converted into one operating command executable by the task belonging to the OS layer. When the MFP process layer receives operation identification information from a task belonging to the OS layer, the MFP process layer outputs the operation identification information to the application PF layer.

While the application programs cause MFP 100 to perform the copying process, scanning process, printing process, facsimile transmitting/receiving process, data transmitting/receiving process, and so on, as previously described, the following description will focus on the part related to the processing of controlling operation panel 160, in the processes the application programs cause CPU 111 to perform.

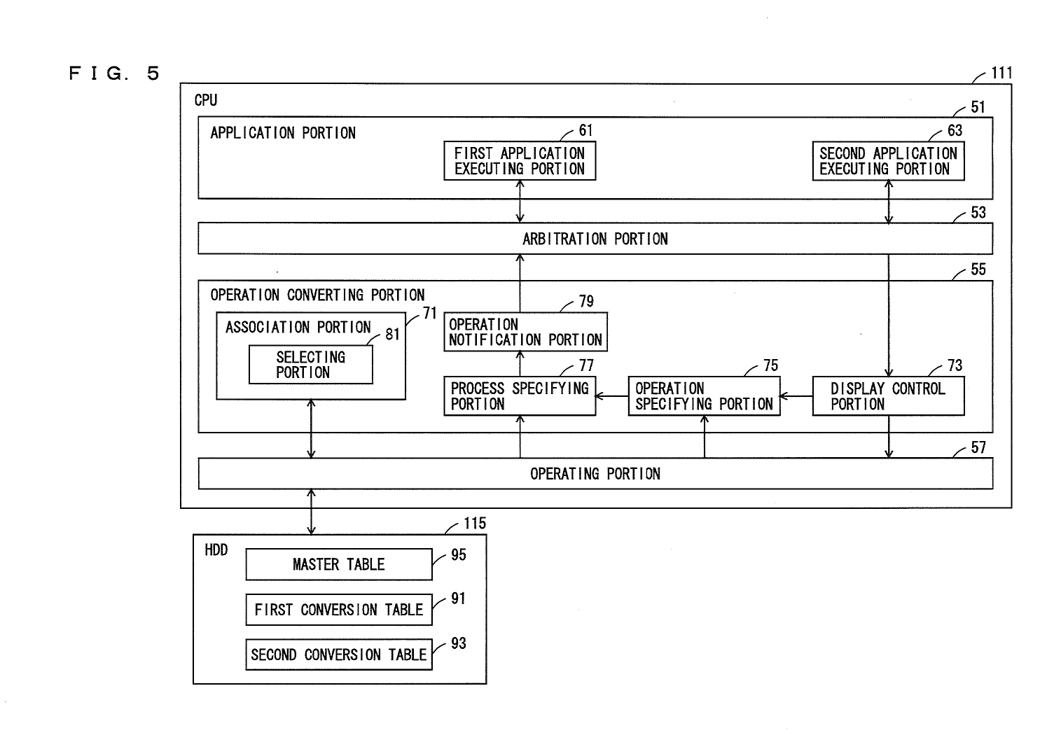

FIG. 5 is a block diagram showing, by way of example, the functions of the CPU included in the MFP, together with data stored in the HDD. The functions shown in FIG. 5 are implemented by CPU 111 included in MFP 100 as CPU 111 executes a program stored in ROM 113, HDD 115, or CD-ROM 118. Specifically, the functions are implemented by CPU 111 as CPU 111 executes an OS program, an operation standardization program, and an application program. The functions of CPU 111 shown in the figure are implemented when a first application program and a second application program are installed in MFP 100 as the application programs.

Referring to FIG. 5, CPU 111 includes an application portion 51, an arbitration portion 53, an operation converting portion 55, and an operating portion 57. Application portion 51 belongs to the application layer in the software architecture shown in FIG. 4. Application portion 51 includes a first application executing portion 61 and a second application executing portion 63. First application executing portion 61 is a function executed by the task for CPU 111 to execute the first application program. Second application executing portion 63 is a function executed by the task for CPU 111 to execute the second application program. Each of first application executing portion 61 and second application executing portion 63 outputs an application command to arbitration portion 53.

First application executing portion 61 specifies a process to be performed, from among a plurality of types of processes determined by the first application program, on the basis of an instruction from an operation user who operates MFP 100, and performs the specified process. Second application executing portion 63 specifies a process to be performed, from among a plurality of types of processes determined by the second application program, on the basis of an instruction from the operation user who operates MFP 100, and performs the specified process.

Arbitration portion 53 and operation converting portion 55 are the functions executed by a task for CPU 111 to execute the operation standardization program. Arbitration portion 53 belongs to the application PF layer in the software architecture shown in FIG. 4. Operation converting portion 55 belongs to the application PF layer and the MFP process layer in the software architecture shown in FIG. 4. While it is here assumed that at least some of the functions included in operation converting portion 55 are the functions of the application PF layer and the rest of the functions are the functions of the MFP process layer, all the functions included in operation converting portion 55 may be the functions of the application PF layer.

Arbitration portion 53 brings either first application executing portion 61 or second application executing portion 63 into a currently selected state in which data can be input/output. Hereinafter, one of first application executing portion 61 and second application executing portion 63 that has been brought into the currently selected state by arbitration portion 53 will be referred to as “current task”. Arbitration portion 53 receives an application command output from the current task, which is either first application executing portion 61 or second application executing portion 63, and outputs the application command and application identification information for identifying the current task, to operation converting portion 55. When first application executing portion 61 is in the currently selected state, first application executing portion 61 is the current task, so that arbitration portion 53 outputs the application identification information for identifying first application executing portion 61 and the application command output from first application executing portion 61, to operation converting portion 55. When second application executing portion 63 is in the currently selected state, second application executing portion 63 is the current task, so that arbitration portion 53 outputs the application identification information for identifying second application executing portion 63 and the application command output from second application executing portion 63, to operation converting portion 55.

When a plurality of application commands are output from each of first and second application executing portions 61, 63, arbitration portion 53 determines the order of the application commands, and sequentially outputs them in the determined order to operation converting portion 55. For example, in the case where a plurality of application commands cannot be executed concurrently, arbitration portion 53 waits until operation converting portion 55 finishes the execution of one application command before arbitration portion 53 outputs another application command to operation converting portion 55. In the case where one application command can be executed only after the execution of another application command is finished, even if the one application command is input earlier than the another application command, arbitration portion 53 outputs the another application command first.

Operation converting portion 55 receives an application command from arbitration portion 53, and converts the application command in accordance with a predetermined rule, for standardization. Even in the case where the first application program and the second application program are different in version and, hence, the application commands output from the first application program and the second application program are different in version from each other, operation converting portion 55 can convert them into standardized application commands. Operation converting portion 55 further converts the standardized application command into an operating command, and outputs the operating commands to operating portion 57. The operating command is a command which is predetermined between operation converting portion 55 and operating portion 57 and which can be interpreted by operating portion 57.

Operating portion 57 is the function performed by a task for CPU 111 to execute an OS program. Operating portion 57 belongs to the OS layer in the software architecture shown in FIG. 4.

Operating portion 57 receives an operating command output from operation converting portion 55, and controls the hardware resources in accordance with the operating command. As the hardware resources, HDD 115, input control portion 167, and display control portion 161 will be described here by way of example. Operating portion 57 controls HDD 115 to store data in HDD 115, or read data stored in HDD 115. Operating portion 57 controls display control portion 161 to cause LCD 165 to display an image.

Further, operating portion 57 accepts identification information of a hard key or position information indicating a position on the display surface of LCD 165, which is output from input control portion 167. When accepting the identification information of a hard key or the position information from input control portion 167, operating portion 57 outputs the accepted identification information of the hard key or the accepted position information, as operation identification information, to operation converting portion 55. The operation identification information is information for identifying the operation designated by an operation user who operates MFP 100, among a plurality of types of operations that can be accepted by hard key portion 170 and touch panel 169.

Operating portion 57 may concurrently accept two or more hard key identification information items or position information items from input control portion 167. For example, in the case where the operation user concurrently depresses two or more of the hard keys in hard key portion 170, operating portion 57 accepts two or more identification information items for respectively identifying the depressed hard keys. In the case where the operation user concurrently designates two different areas on the display surface of LCD 165 with his/her fingers, operating portion 57 accepts two or more position information items respectively indicating the positions designated on the display surface. Further, in the case where the operation user designates a position on the display surface of LCD 165 with his/her finger while depressing one of the plurality of hard keys included in hard key portion 170, operating portion 57 accepts the identification information of the depressed hard key and the position information indicating the position designated on the display surface. In the case of concurrently accepting two or more hard key identification information items or position information items from input control portion 167, operating portion 57 outputs the accepted hard key identification information items or position information items to operation converting portion 55.

Operation converting portion 55 includes an association portion 71, a display control portion 73, an operation specifying portion 75, a process specifying portion 77, and an operation notification portion 79. At the stage when an application program is installed, association portion 71 associates each of a plurality of types of processes determined by the application program with a set of one or more operations among a plurality of types of operations that can be accepted by input control portion 167. HDD 115 stores a master table 95 in advance. In the master table, a respective one of a plurality of process identification information items is associated in advance with a plurality of sets of operation identification information items for one or more operations selected from among the plurality of types of operations that can be accepted by input control portion 167.

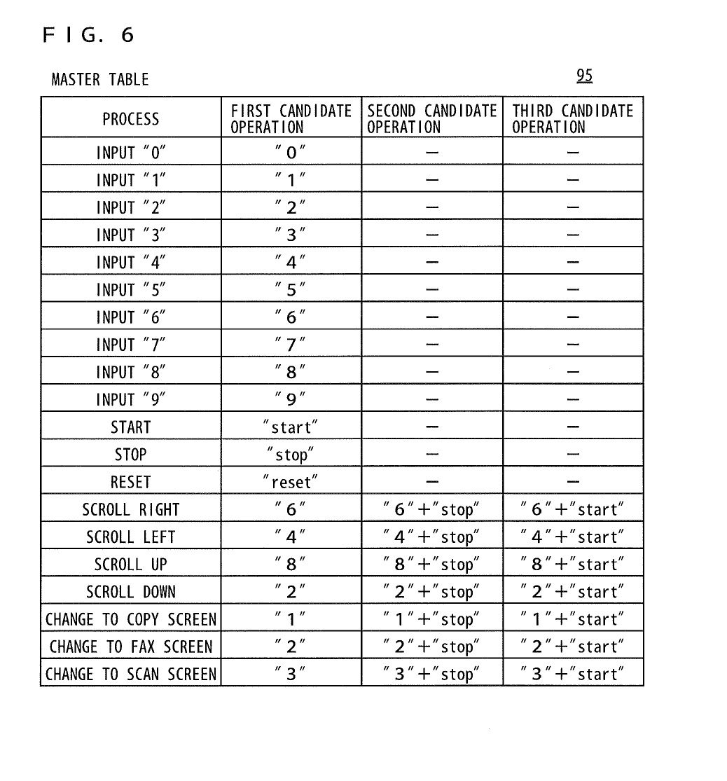

FIG. 6 shows a first example of the master table. Referring to FIG. 6, master table 95 includes a master record for each of a plurality of process identification information items. Each master record includes a “process” field, and “first candidate operation”, “second candidate operation”, and “third candidate operation” fields. In the “process” field, process identification information is set. In each of the first through third candidate operation fields, a set of one or more operation identification information items is set. The set of operation identification information item(s) that is set in the “first candidate operation” field has a higher priority than the set of operation identification information item(s) that is set in the “second candidate operation” field. The set of operation identification information item(s) that is set in the “second candidate operation” field has a higher priority than the set of operation identification information item(s) that is set in the “third candidate operation” field. The process identification information items are predetermined. Therefore, in the case where an application program is newly developed and the new application program includes a new process identification information item different from the process identification information items included in the master table, master table 95 is updated so as to include a master record including the new process identification information item.

Further, master table 95 corresponds to hard key portion 170. Start key 171, stop key 173, reset key 175, and the keys in numerical keypad 177 included in hard key portion 170 are associated respectively with default process identification information items. In a master record including the process identification information item that has been associated by default with one of start key 171, stop key 173, reset key 175, and the keys in numerical keypad 177 included in hard key portion 170, a set of operation identification information item(s) is set only in the “first candidate operation” field, while no operation identification information is set in the “second candidate operation” field and “third candidate operation” field. For example, the key having key identification information “0” has been associated with default process identification information “input “0””. In the master record in which “input “0”” is set as the process identification information in the “process” field, only the key identification information “0” is set as the operation identification information in the “first candidate operation” field; nothing is set in the “second candidate operation” field and “third candidate operation” field.

Returning to FIG. 5, association portion 71 includes a selecting portion 81. Selecting portion 81 reads master table 95 stored in HDD 115. More specifically, selecting portion 81 outputs an operating command to read master table 95 to operating portion 57, which in turn controls HDD 115 to read master table 95. Selecting portion 81 acquires the read master table 95. At the stage when an application program is installed, selecting portion 81 refers to master table 95 to select, for each of process identification information items corresponding respectively to a plurality of types of processes determined by the application program, a set of operation identification information item(s) that has not been assigned to any other one of the process identification information items, from among the plurality of sets of operation identification information items associated by master table 95 with that process identification information item.

More specifically, when master table 95 includes a first master record in which a single set of one or more operation identification information items is associated with a process identification information item, selecting portion 81 classifies a plurality of master records included in master table 95 as first master records in each of which a single set of operation identification information item(s) is associated, and second master records in each of which two or more sets of operation identification information items are associated. Then, selecting portion 81 refers to the first master records to select the set of operation identification information item(s) that is associated with the process identification information item corresponding to one of a plurality of types of processes determined by the application program. Next, selecting portion 81 refers to the second master records each having a plurality of sets of operation identification information items associated with one process identification information item. Among the process identification information items corresponding respectively to the plurality of types of processes determined by the application program, as to the process identification information item to which a set of operation identification information item(s) has not been selected yet, selecting portion 81 refers to the second master record to select, from among the plurality of sets of operation identification information items, a set of operation identification information item(s) that has not been assigned to any other process identification information item and that has the highest priority. In each second master record, the sets of operation identification information items associated with a process identification information item are assigned priorities. Therefore, in the case where a plurality of types of application programs are installed, it is highly likely that the same set of operation identification information item(s) is associated with the identical processes in those application programs. This can facilitate the operations when a plurality of types of application programs are installed.

Association portion 71 generates conversion records in each of which one of process identification information items corresponding respectively to a plurality of types of processes determined by an application program is associated with a set of one or more operation identification information items selected by selecting portion 81 for that process identification information item, and adds the generated conversion records to a conversion table.

There may be a process, among a plurality of types of processes determined by an application program, for which selecting portion 81 selects none of the plurality of sets of operation identification information items associated by master table 95 with its process identification information item. For example, in the case where master table 95 does not include a master record having that process identification information item set in the “process” field, or even when master table 95 includes such a master record, in the case where the three sets of operation identification information items set in the first through third candidate operation fields have already been selected for other process identification information items, none of the sets of operation identification information items is selected for that process identification information item. When there is any process identification information item for which no set of operation identification information item(s) was selected by selecting portion 81, association portion 71 generates a soft key. A soft key, which is an image displayed on LCD 165, is associated with a predetermined operation identification information item. A plurality of soft keys may be prepared in advance, and the prepared soft keys may be selected one by one. Association portion 71 generates a conversion record in which the operation identification information of the soft key is associated with the process identification information item for which no set of operation identification information item(s) was selected by selecting portion 81, and adds the generated conversion record to the conversion table.

Association portion 71 stores a conversion table which has been generated for an application program, in HDD 115, in association with the application program. Specifically, at the stage when a first application program is installed, association portion 71 generates a first conversion table 91 for the first application program, and stores the table in HDD 115. At the stage when a second application program is installed, association portion 71 generates a second conversion table 93 for the second application program, and stores the table in HDD 115. More specifically, association portion 71 outputs to operating portion 57 an operating command to store first conversion table 91 or second conversion table 93, and operating portion 57 in turn controls HDD 115 to store first conversion table 91 or second conversion table 93.

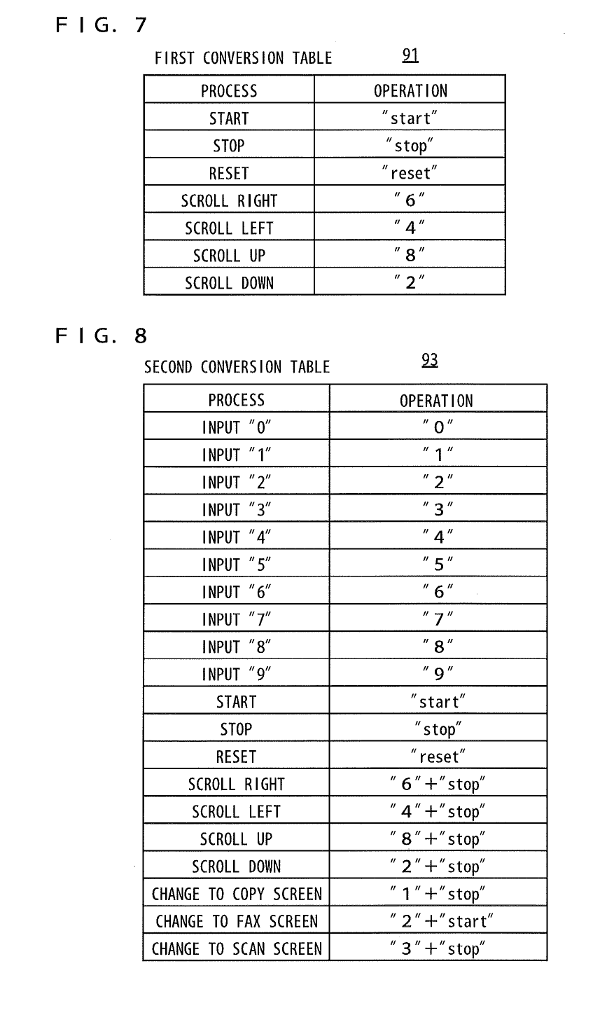

FIG. 7 shows a first example of a first conversion table. Referring to FIG. 7, first conversion table 91 is generated at the stage when the first application program is installed into MFP 100. First conversion table 91 includes conversion records which correspond respectively to a plurality of types of processes determined by the first application program. Each conversion record includes a “process” field and an “operation” field. In the “process” field, a process identification information item for identifying one of the plurality of types of processes determined by the first application program is set. In the “operation” field, a set of operation identification information item(s) for one or more operations is set.

Here, the process identification information items for the plurality of types of processes determined by the first application program are: “start”, “stop”, “reset”, “scroll right”, “scroll left”, “scroll up”, and “scroll down”. Master table 95 shown in FIG. 6 includes first master records in each of which a single set of one or more operation identification information items is associated with one process identification information item. Therefore, the process identification information “start” is associated with the operation identification information “start” of the first priority that has been set in the “first candidate operation” field in the first master record, the process identification information “stop” is associated with the operation identification information “stop” of the first priority that has been set in the “first candidate operation” field in the first master record, and the process identification information “reset” is associated with the operation identification information “reset” of the first priority that has been set in the “first candidate operation” field in the first master record.

As to the process identification information “scroll right”, in accordance with the second master record, it is associated with the operation identification information “6” of the first priority that has been set in the “first candidate operation” field. Similarly, the process identification information “scroll left” is associated with the operation identification information “4”, the process identification information “scroll up” is associated with the operation identification information “8”, and the process identification information “scroll down” is associated with the operation identification information “2”.

FIG. 8 shows a first example of a second conversion table. Referring to FIG. 8, second conversion table 93 is generated at the stage when the second application program is installed into MFP 100. Second conversion table 93 includes conversion records which correspond respectively to a plurality of types of processes determined by the second application program. Each conversion record includes a “process” field and an “operation” field. In the “process” field, a process identification information item for identifying one of the plurality of types of processes determined by the second application program is set. In the “operation” field, a set of operation identification information item(s) for one or more operations is set.

Here, the process identification information items for the plurality of types of processes determined by the second application program are: “input “0”” to “input “9””, “start”, “stop”, “reset”, “scroll right”, “scroll left”, “scroll up”, “scroll down”, “change to copy screen”, “change to FAX screen”, and “change to scan screen”. Master table 95 shown in FIG. 6 includes first master records in each of which a single set of one or more operation identification information items is associated with one process identification information item. Therefore, as to the process identification information items “input “0”” to “input “9””, “start”, “stop”, and “reset”, the process identification information items “input “0”” to “input “9”” are associated respectively with the operation identification information items “0” to “9” of the first priority that have been set in the “first candidate operation” fields in the first master records, the process identification information “start” is associated with the operation identification information “start” of the first priority that has been set in the “first candidate operation” field in the first master record, the process identification information “stop” is associated with the operation identification information “stop” of the first priority that has been set in the “first candidate operation” field in the first master record, and the process identification information “reset” is associated with the operation identification information “reset” of the first priority that has been set in the “first candidate operation” field in the first master record.

As to the process identification information “scroll right”, the operation identification information “6” of the first priority that is set in the “first candidate operation” field in the second master record has already been associated with the process identification information “input “6””, and therefore, the process identification information “scroll right” is associated with the set of operation identification information items ““6”+“stop”” of the second priority that is set in the “second candidate operation” field in the second master record. Similarly, the process identification information items “scroll left”, “scroll up”, and “scroll down” are associated respectively with the sets of operation identification information items ““4”+“stop””, ““8”+“stop””, and ““2”+“stop”” of the second priority that are set in the “second candidate operation” fields in the second master records. The process identification information items “change to copy screen” and “change to scan screen” are associated respectively with the sets of operation identification information items ““1”+“stop”” and ““3”+“stop”” of the second priority that are set in the “second candidate operation” fields in the second master records.

Further, as to the process identification information “change to FAX screen”, the operation identification information “2” of the first priority that is set in the “first candidate operation” field in the second master record has already been associated with the process identification information “input “2””, and the set of operation identification information items ““2”+“stop”” of the second priority that is set in the “second candidate operation” field in the second master record has already been associated with the process identification information “scroll down”. Therefore, the process identification information “change to FAX screen” is associated with the set of operation identification information items ““2”+“start”” of the third priority that is set in the “third candidate operation” field in the second master record.

Accordingly, even in the case where a plurality of types of processes determined by the first application program or second application program include any process other than the processes which are associated by default with the hard keys included in hard key portion 170, every one of the processes determined by the first or second application program can be associated with a corresponding set of one or inure hard keys. Further, even in the case where a plurality of processes determined by the first application program and a plurality of processes determined by the second application program are different from each other, every one of the processes determined by the first application program or second application program can be associated with a corresponding set of one or more hard keys.

Returning to FIG. 5, when a set of the application identification information of the current task and the application command instructing to display an operation screen is received from arbitration portion 53, display control portion 73 outputs an operating command, which has been obtained by converting the application command instructing to display an image of the operation screen to the operating command, to operating portion 57, and also outputs the operation screen to operation specifying portion 75. Operating portion 57 controls display control portion 161 to cause LCD 165 to display the image of the operation screen. Further, at the stage when the application identification information of the current task is input from arbitration portion 53, display control portion 73 causes LCD 165 to display an image of an operation list screen, on the basis of the conversion table corresponding to the current task. The operation list screen is a screen which displays the process identification information items and the sets of one or more operation identification information items in association with each other. This list shows to the operation user which keys in hard key portion 170 are associated with which processes determined by the application program.

Operation specifying portion 75 receives hard key identification information or position information from operating portion 57, and receives an operation screen from display control portion 73. In the case of receiving the position information from operating portion 57, operation specifying portion 75 determines whether the position on the operation screen specified by the position information is within an image of a button included in the operation screen. If the position on the operation screen specified by the position information is within an image of a button (soft key) included in the operation screen, operation specifying portion 75 specifies the operation corresponding to the button and outputs the operation identification information of the specified operation to process specifying portion 77. For example, in the case where an operation screen includes a print instruction button for instructing to execute the print operation, when the position on the operation screen specified by the position information is within the image of the print instruction button, operation specifying portion 75 outputs the operation identification information that has been assigned to the operation of designating the print instruction button, to process specifying portion 77.

In the case of receiving the hard key identification information from operating portion 57, operation specifying portion 75 specifies the operation of depressing the hard key corresponding to the identification information, and outputs the operation identification information of the specified operation to process specifying portion 77. For example, when the hard key having the numeric character “1” represented thereon has been depressed, operation specifying portion 75 outputs the operation identification information “1” that has been assigned to the operation of depressing the hard key with the numeric character “1”, to process specifying portion 77.

Operation specifying portion 75 may concurrently receive from operating portion 57 a plurality of hard key identification information items, a plurality of position information items, or a set of hard key identification information item and position information item. In the case where a plurality of hard key identification information items, a plurality of position information items, or a set of hard key identification information item and position information item is concurrently input from operating portion 57, operation specifying portion 75 specifies a plurality of operations corresponding respectively to the received hard key identification information items or position information items, and outputs a plurality of operation identification information items assigned respectively to the specified operations, to process specifying portion 77.

Process specifying portion 77 receives the application identification information of the current task from arbitration portion 53, and receives one or more operation identification information items from operation specifying portion 75. In response to reception of the application identification information of the current task from arbitration portion 53, process specifying portion 77 reads one of first conversion table 91 and second conversion table 93 stored in HDD 115 that corresponds to the application identification information of the current task. When the current task is first application executing portion 61, process specifying portion 77 reads first conversion table 91. When the current task is second application executing portion 63, process specifying portion 77 reads second conversion table 93. More specifically, process specifying portion 77 outputs an operating command to read first conversion table 91 or second conversion table 93, to operating portion 57, which in turn controls HDD 115 to read first conversion table 91 or second conversion table 93. Process specifying portion 77 acquires the read table. In the following description, it is assumed that first application executing portion 61 is the current task.

When process specifying portion 77 receives one or more operation identification information items from operation specifying portion 75, process specifying portion 77 specifies, on the basis of a set of one or more operations specified respectively by the one or more operation identification information items, one of a plurality of types of processes that has been associated in correspondence with the first application program. Specifically, process specifying portion 77 specifies a process that is associated, by first conversion table 91, with the set of one or more operations specified by the one or more operation identification information items received from operation specifying portion 75. More specifically, process specifying portion 77 extracts, from first conversion table 91, a conversion record in which the set of the operation identification information item(s) input from operation specifying portion 75 is set in the “operation” field, and acquires the process identification information that is set in the “process” field in the extracted conversion record. Process specifying portion 77 outputs a set of the acquired process identification information and the application identification information of the current task, to operation notification portion 79.

In response to reception of the set of the process identification information and the application identification information from process specifying portion 77, operation notification portion 79 outputs the process identification information to the current task specified by the application identification information. Specifically, operation notification portion 79 generates an application command for causing a process specified by the process identification information to be performed. Then, operation notification portion 79 requests arbitration portion 53 to output the generated application command to the current task specified by the application identification information, i.e. first application executing portion 61 here.

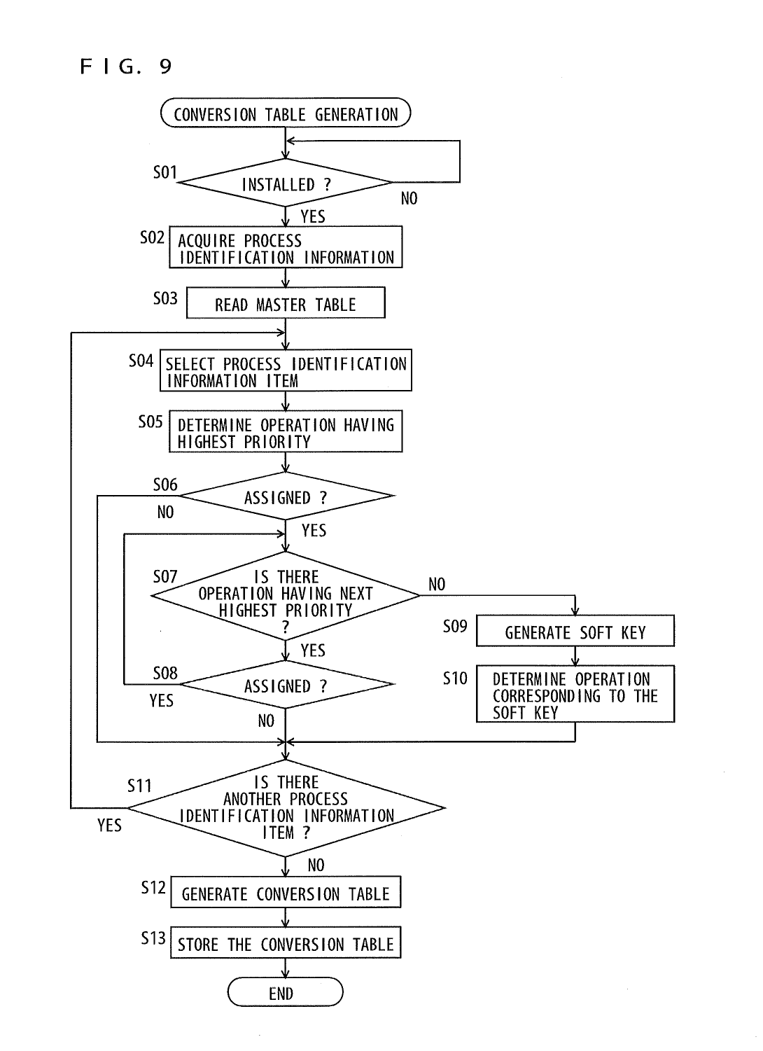

FIG. 9 is a flowchart illustrating an example of the flow of a conversion table generating process. The conversion table generating process is carried out by CPU 111 included in MFP 100 as CPU 111 executes an operation standardization program stored in ROM 113, HDD 115, or CD-ROM 118.

Referring to FIG. 9, CPU 111 determines whether an application program has been installed (step S01). CPU 111 is in a standby mode until a new application program is installed (“NO” in step S01), and once a new application program is installed, the process proceeds to step S02. In other words, the conversion table generating process is carried out on the condition that a new application program is installed.

In step S02, CPU 111 acquires process identification information items for a plurality of types of processes determined by the newly installed application program. CPU 111 acquires the process identification information items of the plurality of types of processes described in the application program during the installation of the application program. It is noted that CPU 111 may acquire the process identification information items from a task that executes the installed application program.

In step S03, CPU 111 reads master table 95 stored in HDD 115. Then, CPU 111 selects one of the process identification information items acquired in step S02, as a process target (step S04). In the following step S05, CPU 111 determines an operation having the highest priority. Specifically, CPU 111 extracts, from the master records included in master table 95, a master record in which the process identification information selected as a process target is set in the “process” field, and determines the set of one or more operation identification information items set in the “first candidate operation” field in the extracted master record to be the operation(s) having the highest priority. CPU 111 then determines the operation(s) having the highest priority as the operation(s) corresponding to the process specified by the process identification information item that has been selected as a process target in step S04. More specifically, CPU 111 associates the process identification information item selected as a process target in step S04, with the set of one or more operation identification information items set in the “first candidate operation” field in the extracted master record.

In the following step S06, CPU 111 determines whether the set of one or more operation identification information items determined to be the operation(s) having the highest priority has already been assigned to another process identification information item. If so, the process proceeds to step S07; otherwise, the process proceeds to step S11.

In step S07, CPU 111 determines whether there is an operation having the highest priority next to the currently determined operation. If so, CPU 111 determines the operation having the next highest priority as the operation corresponding to the process specified by the process identification information item that has been selected as a process target in step S04, and the process proceeds to step S08. More specifically, CPU 111 associates the process identification information item that has been selected as a process target in step S04, with the set of one or more operation identification information items of the operation(s) having the highest priority next to the currently determined operation. If there is no operation having the highest priority next to the currently determined operation, the process proceeds to step S09.

More specifically, if the currently determined operation is the first candidate operation in the master record extracted in step S05, CPU 111 determines that there is an operation having the next highest priority, and associates the set of one or more operation identification information items that has been set as the second candidate operation, with the process identification information item selected as a process target in step S04, and the process proceeds to step S08. If the currently determined operation is the second candidate operation in the master record extracted in step S05, CPU 111 determines that there is an operation having the next highest priority, and associates the set of one or more operation identification information items that has been set as the third candidate operation, with the process identification information item selected as a process target in step S04, and the process proceeds to step S08. If the currently determined operation is the third candidate operation in the master record extracted in step S05, CPU 111 determines that there is no operation having the next highest priority, and the process proceeds to step S09.

In step S08, CPU 111 determines whether the set of one or more operation identification information items determined in step S07 has already been assigned to another operation identification information item. If so, the process returns to step S07; otherwise, the process proceeds to step S11.

On the other hand, in step S09, CPU 111 generates a soft key. CPU 111 selects one of a plurality of predetermined soft keys for the process identification information item that has been selected as a process target in step S04. In the following step S10, CPU 111 determines the operation corresponding to the generated soft key as the operation corresponding to the process specified by the process identification information item that has been selected as a process target in step S04, and the process proceeds to step S11. Specifically, CPU 111 associates the process identification information item selected as a process target in step S04, with the operation identification information assigned to the operation corresponding to the generated soft key.

When the process proceeds to step S11, a set of one or more operation identification information items or the operation identification information assigned to the operation corresponding to the soft key has been determined as the operation for the process identification information item selected as a process target in step S04. In step S11, CPU 111 determines whether there is any process identification information item that has not been selected as a process target, among the process identification information items acquired in step S02. If so, the process returns to step S04; otherwise, the process proceeds to step S12. When the process proceeds to step S12, the sets of one or more operation identification information items have been set as the operations for all the process identification information items acquired in step S02. In step S12, CPU 111 generates a conversion table, and the process proceeds to step S13. More specifically, CPU 111 generates a conversion table in which the operation determined in step S05 or step S07, which is here the set of one or more operation identification information items, is associated with each of the plurality of process identification information items acquired in step S02.

In the following step S13, CPU 111 stores the generated conversion table, and the process is terminated. Specifically, CPU 111 stores the conversion table in HDD 115, in association with the application program installed in step S01. Accordingly, when a first application program is installed, a first conversion table 91 associated with the first application program is stored in HDD 115. When a second application program is installed, a second conversion table 93 associated with the second application program is stored in HDD 115.

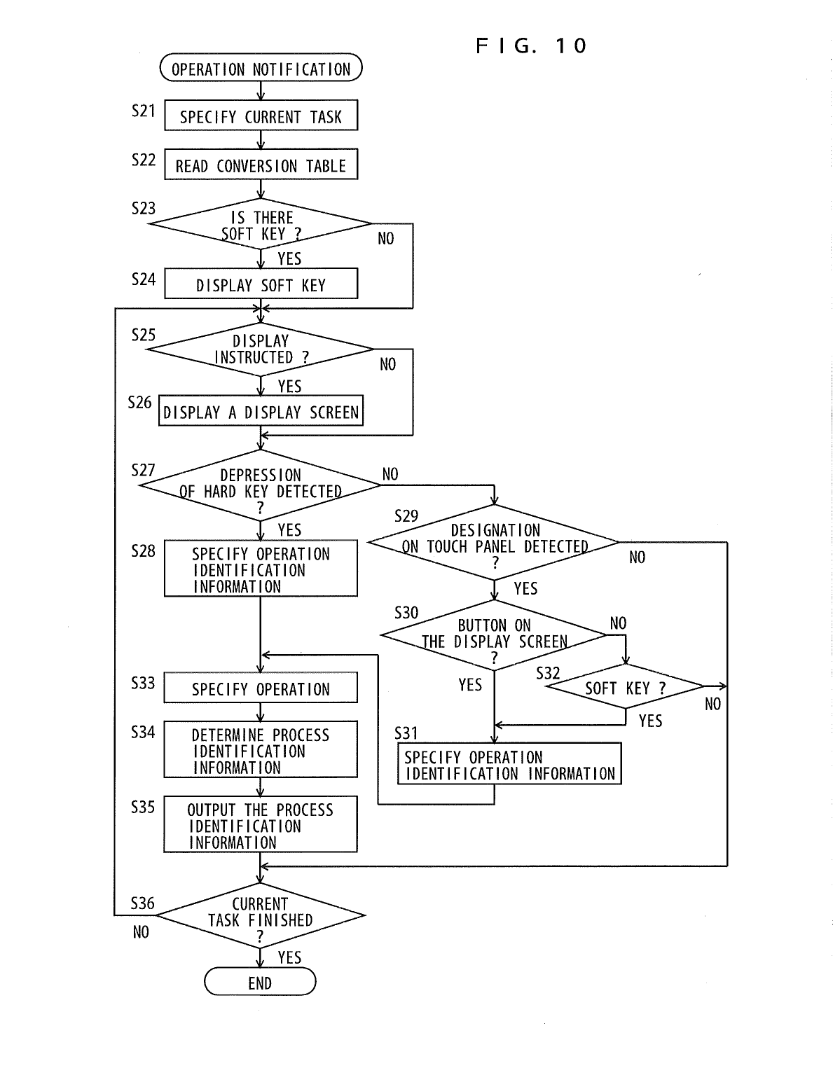

FIG. 10 is a flowchart illustrating an example of the flow of an operation notification process. The operation notification process is carried out by CPU 111 included in MFP 100 as CPU 111 executes the operation standardization program stored in ROM 113, HDD 115, or CD-ROM 118. Referring to FIG. 10, CPU 111 specifies a current task (step S21). CPU 111 determines whether the current task is a task for executing the first application program or a task for executing the second application program. In the following description, it is assumed that the task for executing the first application program is specified as the current task.

In step S22, CPU 111 reads a conversion table. CPU 111 reads the conversion table which is associated with the application program that is executed by the task specified as the current task in step S21. As it is here assumed that the task for executing the first application program is the current task, CPU 111 reads first conversion table 91 associated with the first application program from HDD 115.

In the following step S23, CPU 111 determines whether a soft key is defined in the conversion table. Specifically, CPU 111 determines whether there is any conversion record in which operation identification information of a soft key has been set in the “operation” field. If there is such a conversion record, the process proceeds to step S24; otherwise, the process proceeds to step S25, with step S24 being skipped.

In step S24, CPU 111 displays the soft key, and the process proceeds to step S25. Specifically, CPU 111 extracts, from the conversion table, any conversion record in which the operation identification information of a soft key is set in the “operation” field, and CPU 111 displays an image of each soft key specified by the operation identification information on LCD 165.

In step S25, CPU 111 determines whether a display instruction has been accepted. If so, the process proceeds to step S26; otherwise, the process proceeds to step S27, with step S26 being skipped. When the task for executing the first application program outputs an application command instructing to display a display screen, the display instruction is accepted. For example, in the case where the task for executing the first application program displays an initial screen such as a menu screen at the stage when the first application program is executed, the task outputs an application command instructing to display the initial screen. Further, in the case of switching a display screen, the task for executing the first application program outputs an application command instructing to display the switched display screen. In step S26, CPU 111 displays a display screen in accordance with the display instruction, and the process proceeds to step S27. CPU 111 displays the display screen specified by the application command on LCD 165.

In step S27, CPU 111 determines whether an operation of depressing a hard key has been detected. When identification information of a hard key is received from input control portion 167, CPU 111 detects the depression of the hard key. If CPU 111 detects the depression of the hard key, the process proceeds to step S28; otherwise, the process proceeds to step S29. In step S28, CPU 111 specifies the operation identification information corresponding to the identification information of the hard key that was received from input control portion 167 in step S27, and the process proceeds to step S33. It is noted that when CPU 111 receives identification information items of two or more hard keys concurrently from input control portion 167, CPU 111 specifies the operation identification information items corresponding respectively to the two or more hard key identification information items.

On the other hand, in step S29, CPU 111 determines whether an operation of designating the touch panel has been detected. When position information indicating a position on the display surface of LCD 165 is received from input control portion 167, CPU 111 detects the operation of designating the touch panel. If CPU 111 detects the operation of designating the touch panel, the process proceeds to step S30; otherwise, the process proceeds to step S36. In step S30, CPU 111 determines whether the position specified by the position information is within an image of a button on the display screen displayed in step S26. If the position on the operation screen specified by the position information is within the image of the button included in the display screen, the process proceeds to step S31; otherwise, the process proceeds to step S32.

In step S32, CPU 111 determines whether the position specified by the position information is within the image of the soft key displayed in step S24. If the position on the operation screen specified by the position information is within the image of the soft key, the process proceeds to step S31; otherwise, the process proceeds to step S36.

When the process proceeds from step S30 to step S31, in step S31, CPU 111 specifies the operation identification information corresponding to the button located at the position specified by the position information, and the process proceeds to step S33. When the process proceeds from step S32 to step S31, in step S31, CPU 111 specifies the operation identification information corresponding to the soft key located at the position specified by the position information, and the process proceeds to step S33.

In step S33, CPU 111 specifies the operation(s) corresponding to the set of one or more operation identification information items specified in step S28 or step S31. If first conversion table 91 read in step S22 includes a conversion record in which the set of one or more operation identification information items specified in step S28 or step S31 is set in the “operation” field, CPU 111 extracts the conversion record and specifies the operation(s). In the following step S34, CPU 111 determines the process identification information. CPU 111 determines the process identification information that is set in the “process” field in the extracted conversion record. In the following step S35, CPU 111 outputs the determined process identification information to the current task specified in step S21, i.e. the task for executing the first application program here, and the process proceeds to step S36. Specifically, CPU 111 generates an application command including the determined process identification information, and outputs the generated application command to the task for executing the first application program.

In step S36, CPU 111 determines whether the current task is finished. If the current task specified in step S21 is finished, the process is terminated; otherwise, the process returns to step S25.

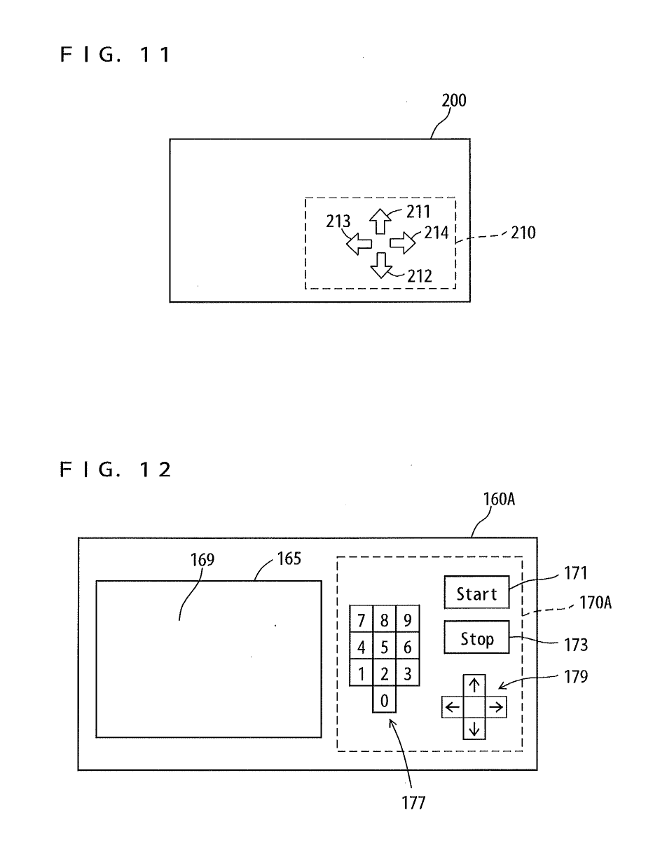

FIG. 11 shows examples of soft keys. Referring to FIG. 11, soft keys 210 are displayed overlaid on an operation screen 200, by way of example. Soft keys 210 include an up arrow key 211, a down arrow key 212, a left arrow key 213, and a right arrow key 214. For example, up arrow key 211 can be associated with operation identification information “soft key “↑””, down arrow key 212 can be associated with operation identification information “soft key “↓””, left arrow key 213 can be associated with operation identification information “soft key “←””, and right arrow key 214 can be associated with operation identification information “soft key “→””. The four operations can be added to the operations of depressing the respective hard keys included in hard key portion 170.

<Configuration with Different Hard Keys>

A description will be made below about the case where a first application program and a second application program are installed into another MFP.

FIG. 12 is a plan view of an operation panel in another MFP. Referring to FIG. 12, an operation panel 160A in the MFP other than MFP 100 is different from operation panel 160 shown in FIG. 3 in that a hard key portion 170A does not include reset key 175 having the key identification information “Reset”, and includes up, down, right, and left arrow keys 179.

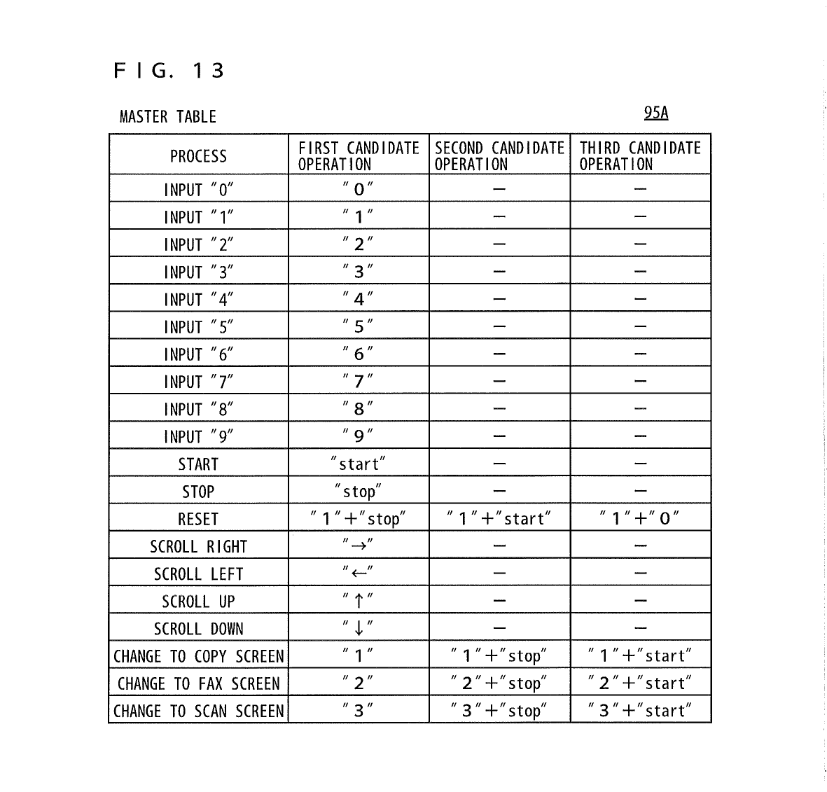

FIG. 13 shows a second example of a master table. The master table 95A shown in FIG. 13 is stored in advance in the MFP other than MFP 100.

Referring to FIG. 13, master table 95A includes a master record for each of a plurality of process identification information items, just like master table 95 stored in MFP 100 shown in FIG. 6. Master table 95A corresponds to hard key portion 170A. Start key 171, stop key 173, the keys in numerical keypad 177, and arrow keys 179 included in hard key portion 170A are associated respectively with default process identification information items. In a master record including the process identification information item that has been associated by default with one of start key 171, stop key 173, the keys in numerical keypad 177, and arrow keys 179 included in hard key portion 170A, a set of operation identification information item(s) is set only in the “first candidate operation” field, while no operation identification information is set in the “second candidate operation” field and “third candidate operation” field. For example, the key having key identification information “→” has been associated with default process identification information “scroll right”. In the master record in which “scroll right” is set as the process identification information in the “process” field, only the key identification information “→” is set as the operation identification information in the “first candidate operation” field; nothing is set in the “second candidate operation” field and “third candidate operation” field.

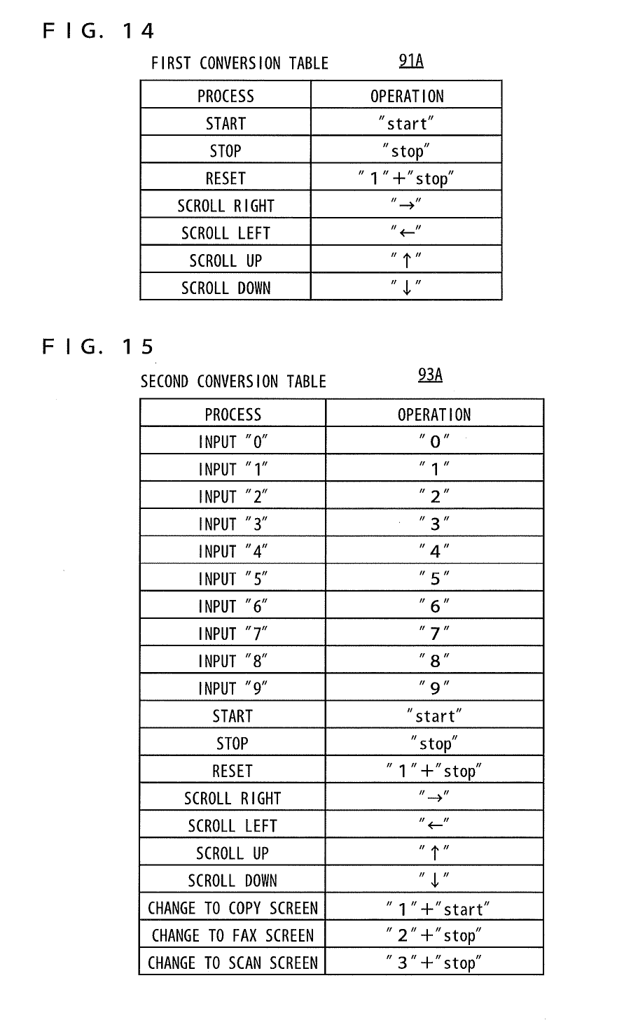

FIG. 14 shows a second example of the first conversion table. Referring to FIG. 14, a first conversion table 91A is generated at the stage when the first application program is installed into the other MFP. First conversion table 91A includes conversion records which correspond respectively to a plurality of types of processes determined by the first application program, as in the first conversion table shown in FIG. 7.

Here, the process identification information items for the plurality of types of processes determined by the first application program are: “start”, “stop”, “reset”, “scroll right”, “scroll left”, “scroll up”, and “scroll down”. Master table 95A shown in FIG. 13 includes first master records in each of which a single set of one or more operation identification information items is associated with one process identification information item. Therefore, as to the process identification information items “start”, “stop”, “scroll right”, “scroll left”, “scroll up”, and “scroll down”, they are associated with the operation identification information items in accordance with the first master records. Specifically, the process identification information “start” is associated with the operation identification information “start”, the process identification information “stop” is associated with the operation identification information “stop”, the process identification information “scroll right” is associated with the operation identification information “→”, the process identification information “scroll left” is associated with the operation identification information “←”, the process identification information “scroll up” is associated with the operation identification information “↑”, and the process identification information “scroll down” is associated with the operation identification information “↓”.

As to the process identification information “reset”, in accordance with the second master record, it is associated with the operation identification information ““1”+“stop”” of the first priority that has been set in the “first candidate operation” field for the process identification information “reset”.

FIG. 15 shows a second example of the second conversion table. Referring to FIG. 15, a second conversion table 93A is generated at the stage when the second application program is installed into the other MFP. Second conversion table 93A includes conversion records which correspond respectively to a plurality of types of processes determined by the second application program, as in the second conversion table shown in FIG. 8.

Here, the process identification information items for the plurality of types of processes determined by the second application program are: “input “0”” to “input “9””, “start”, “stop”, “reset”, “scroll right”, “scroll left”, “scroll up”, “scroll down”, “change to copy screen”, “change to FAX screen”, and “change to scan screen”. Master table 95A shown in FIG. 13 includes first master records in each of which a single set of one or more operation identification information items is associated with one process identification information item.

Therefore, as to the process identification information items “input “0”” to “input “9””, “start”, and “stop”, the process identification information items “input “0”” to “input “9”” are associated respectively with the operation identification information items “0” to “9” of the first priority that have been set in the “first candidate operation” fields in the first master records, the process identification information “start” is associated with the operation identification information “start” of the first priority that has been set in the “first candidate operation” field in the first master record, and the process identification information “stop” is associated with the operation identification information “stop” of the first priority that has been set in the “first candidate operation” field in the first master record.

Similarly, the process identification information “scroll right” is associated with the operation identification information “→”, the process identification information “scroll left” is associated with the operation identification information “←”, the process identification information “scroll up” is associated with the operation identification information “↑”, and the process identification information “scroll down” is associated with the operation identification information “↓”.

As to the process identification information “reset”, in accordance with the second master record, it is associated with the operation identification information ““1”+“stop”” of the first priority that has been set in the “first candidate operation” field for the process identification information “reset”.

Further, as to the process identification information items “change to FAX screen” and “change to scan screen”, in accordance with the second master records, they are associated respectively with the sets of operation identification information items ““2”+“stop”” and ““3”+“stop”” of the second priority that are set in the “second candidate operation” fields, because the operation identification information items “2” and “3” of the first priority that are set in the “first candidate operation” fields have already been associated with the process identification information items “input “2”” and “input “3””, respectively.

Further, as to the process identification information “change to copy screen”, in accordance with the second master record, it is associated with the set of operation identification information items ““1”+“start”” of the third priority that is set in the “third candidate operation” field, because the operation identification information “1” of the first priority that is set in the “first candidate operation” field has already been associated with the process identification information “input “1””, and the set of operation identification information items ““1”+“stop”” of the second priority that is set in the “second candidate operation” field has already been associated with the process identification information “reset”.

Accordingly, the same first application program or the same second application program can be installed into MFP 100 and another MFP having hard keys different from those in MFP 100. This allows an application program developer to create an application program without the need to take into consideration the hard keys included in an apparatus into which the application program is to be installed.

As described above, MFP 100 according to the present embodiment serves as an image processing apparatus. At the stage when an application program is installed, MFP 100 generates a conversion table in which, for the application program, a plurality of types of processes determined by the application program are associated respectively with sets of one or more operations among a plurality of types of operations that can be accepted by MFP 100. This enables an application program determining a new process that has not been executed by MFP 100 before to be installed into MFP 100.

Further, a plurality of types of processes determined by an application program can be associated by a conversion table with a plurality of types of operations that can be accepted by MFP 100. Therefore, an application program can be developed irrespective of the plurality of types of operations that can be accepted by MFP 100. This facilitates the development of an application program.

Furthermore, master table 95 is stored in which process identification information items of a plurality of types of processes are associated, in advance, respectively with a plurality of sets of operation identification information items of one or more operations among a plurality of types of operations. Conversion table 91, 93 is generated by selecting, for a respective one of process identification information items of a plurality of types of processes determined by an application program, a set of operation identification information item(s) that has been associated with that process identification information item by master table 95 and that has not been assigned to any other process identification information item. As one operation can be associated with one process in this manner, it is possible to determine the operations for performing the respective processes determined by the application program.

Further, in master table 95 in which each of a plurality of process identification information items is associated with a plurality of sets of operation identification information items for one or more operations among a plurality of types of operations, the sets of operation identification information items associated with one process identification information item are assigned priorities, and a set having higher priority is selected from among those sets. In the case where a plurality of types of application programs are installed, it is highly likely that the same set of operation identification information item(s) is associated with the identical processes in those application programs. As such, operations having higher priority are associated with a plurality of processes. This can facilitate the operations when a plurality of types of application programs are installed.

Still further, even in the case where a plurality of types of application programs are installed, conversion tables are generated for the respective application programs. It is thus possible to determine operations for performing a plurality of types of processes determined by the respective application programs.

A plurality of types of processes determined by an application program can be associated with operations of depressing a plurality of hard keys having contact switches.

Further, in the case where an image of a soft key is displayed on LCD 165, when the position on the display surface of LCD 165 designated by an operation user on touch panel 169 is within the image of the soft key, an operation corresponding to the soft key is specified. As such, a plurality of types of processes determined by an application program can be associated with operations of designating soft keys.

While MFP 100 has been described as an example of the image processing apparatus in the above embodiment, the present invention may of course be understood as an operation standardization method for causing CPU 111 controlling MFP 100 to perform the processing shown in FIGS. 9 and 10, or as an operation standardization program for causing CPU 111 to perform the operation standardization method.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. An image processing apparatus including
an operation accepting portion to accept an operation designated by an operation user from among a plurality of types of operations, and
a control portion to control said operation accepting portion,
said control portion comprising:
an operating portion operative, in response to acceptance by said operation accepting portion of said operation designated by the operation user, to output operation identification information for identifying said designated operation;
an application portion operative, in response to reception of one of a plurality of process identification information items for respectively identifying a plurality of types of processes determined by an application program, to perform a process of the type that corresponds to said received process identification information item among said plurality of types of processes;
an association portion operative, at the stage when said application program is installed, to associate, for said application program, a respective one of said plurality of types of processes determined by said application program with a set of one or more operations among said plurality of types of operations;
a process specifying portion operative, in response to output by said operating portion of one or more said operation identification information items, to specify a process among said plurality of types of processes that has been associated with a set of one or more operations specified by said output operation identification information item(s), for said application program, by said association portion; and
an operation notification portion to output the process identification information of said specified process to said application portion.

2. The image processing apparatus according to claim 1, wherein said association portion includes a selecting portion, the selecting portion referring to a master table in which a respective one of a plurality of process identification information items is associated in advance with a plurality of sets of one or more operation identification information items of one or more operations among said plurality of types of operations, to select, for a respective one of the process identification information items of said plurality of types of processes executable by said application portion, one set that is among the plurality of sets associated by said master table with the process identification information item and that has not been assigned to any other process identification information item.

3. The image processing apparatus according to claim 2, wherein
said master table associates the respective one of the plurality of process identification information items with the plurality of sets of one or more operation identification information items, by assigning priorities to said plurality of sets, and
said selecting portion selects one of said plurality of sets having higher priority.

4. The image processing apparatus according to claim 1, wherein
in the case where a plurality of types of application programs are installed, at the stage when each of the plurality of types of application programs is installed, said association portion associates, for the installed application program, a respective one of said plurality of types of processes determined by said application program with a set of one or more operations among said plurality of types of operations,
said process specifying portion is operative, in response to output by said operating portion of one or more said operation identification information items, to specify the process that has been associated with the set of one or more operations specified by said output operation identification information item(s), by said association portion, for said application program to be executed by said control portion, and
said operation notification portion outputs the process identification information of said specified process to said application portion corresponding to said application program to be executed by said control portion.

5. The image processing apparatus according to claim 1, wherein
said operation accepting portion includes a plurality of contact switches, and
said operating portion is operative, in response to detection of connection of one or more of said plurality of contact switches, to output the operation identification information item(s) corresponding respectively to the one or more contact switches the connections of which have been detected, from among said plurality of types of processes.

6. The image processing apparatus according to claim 1, wherein
said operation accepting portion includes
a display portion to display an image, and
a position detecting portion to detect that position on a display surface of said display portion which is designated by an operation user,
said operating portion outputs the position on said display surface detected by said position detecting portion as the operation identification information, and
said control portion further comprises:
a button display control portion to display an image of a button on said display portion via said operating portion; and
an operation specifying portion operative, in response to an event that the position on said display surface indicated by the operation identification information output from said operating portion is within the image of the button displayed on said display portion, to specify an operation corresponding to the button.

7. An operation standardization method performed by a computer, the computer controlling an image processing apparatus including an operation accepting portion for accepting an operation designated by an operation user from among a plurality of types of operations,
said computer including
an operating portion operative, in response to acceptance by said operation accepting portion of said operation designated by the operation user, to output operation identification information for identifying said designated operation, and
an application portion operative, in response to reception of one of a plurality of process identification information items for respectively identifying a plurality of types of processes determined by an application program, to perform a process of the type that corresponds to said received process identification information item among said plurality of types of processes,
the method causing said computer to execute:
an association step of, at the stage when said application program is installed, associating, for said application program, a respective one of said plurality of types of processes determined by said application program with a set of one or more operations among said plurality of types of operations;
a process specifying step of, in response to output by said operating portion of one or more said operation identification information items, specifying a process among said plurality of types of processes that has been associated with a set of one or more operations specified by said output operation identification information item(s), in said association step, for said application program; and
an operation notification step of outputting the process identification information of said specified process to said application portion.

8. The operation standardization method according to claim 7, wherein said association step includes a selecting step of referring to a master table in which a respective one of a plurality of process identification information items is associated in advance with a plurality of sets of one or more operation identification information items of one or more operations among said plurality of types of operations, to select, for a respective one of the process identification information items of said plurality of types of processes executable by said application portion, one set that is among the plurality of sets associated by said master table with the process identification information item and that has not been assigned to any other process identification information item.

9. The operation standardization method according to claim 8, wherein
said master table associates the respective one of the plurality of process identification information items with the plurality of sets of one or more operation identification information items, by assigning priorities to said plurality of sets, and
said selecting step includes a step of selecting one of said plurality of sets having higher priority.

10. The operation standardization method according to claim 7, wherein
said association step includes a step of, in the case where a plurality of types of application programs are installed, at the stage when each of the plurality of types of application programs is installed, associating, for the installed application program, a respective one of said plurality of types of processes determined by said application program with a set of one or more operations among said plurality of types of operations,
said process specifying step includes a step of, in response to output by said operating portion of one or more said operation identification information items, specifying the process that has been associated with the set of one or more operations specified by said output operation identification information item(s), in said association step, for said installed application program to be executed by said computer, and
said operation notification step includes a step of outputting the process identification information of said specified process to said application portion corresponding to said application program to be executed by said computer.

11. The operation standardization method according to claim 7, wherein
said operation accepting portion includes a plurality of contact switches, and
said operating portion is operative, in response to detection of connection of one or more of said plurality of contact switches, to output the operation identification information item(s) corresponding respectively to the one or more contact switches the connections of which have been detected, from among said plurality of types of processes.

12. The operation standardization method according to claim 7, wherein
said operation accepting portion includes
a display portion to display an image, and
a position detecting portion to detect that position on a display surface of said display portion which is designated by an operation user,
said operating portion outputs the position on said display surface detected by said position detecting portion as the operation identification information, and
the method causes said computer to further execute:
a button displaying step of displaying an image of a button on said display portion via said operating portion; and
an operation specifying step of, in response to an event that the position on said display surface indicated by the operation identification information output from said operating portion is within the image of the button displayed on said display portion, specifying an operation corresponding to the button.

13. A non-transitory computer-readable recording medium encoded with an operation standardization program performed by a computer, the computer controlling an image processing apparatus including an operation accepting portion for accepting an operation designated by an operation user from among a plurality of types of operations,
said computer including
an operating portion operative, in response to acceptance by said operation accepting portion of said operation designated by the operation user, to output operation identification information for identifying said designated operation, and
an application portion operative, in response to reception of one of a plurality of process identification information items for respectively identifying a plurality of types of processes determined by an application program, to perform a process of the type that corresponds to said received process identification information item among said plurality of types of processes,
the program causing said computer to execute:
an association step of, at the stage when said application program is installed, associating, for said application program, a respective one of said plurality of types of processes determined by said application program with a set of one or more operations among said plurality of types of operations;
a process specifying step of, in response to output by said operating portion of one or more said operation identification information items, specifying a process among said plurality of types of processes that has been associated with a set of one or more operations specified by said output operation identification information item(s), in said association step, for said application program; and
an operation notification step of outputting the process identification information of said specified process to said application portion.

14. The non-transitory computer-readable recording medium encoded with the operation standardization program according to claim 13, wherein said association step includes a selecting step of referring to a master table in which a respective one of a plurality of process identification information items is associated in advance with a plurality of sets of one or more operation identification information items of one or more operations among said plurality of types of operations, to select, for a respective one of the process identification information items of said plurality of types of processes executable by said application portion, one set that is among the plurality of sets associated by said master table with the process identification information item and that has not been assigned to any other process identification information item.

15. The non-transitory computer-readable recording medium encoded with the operation standardization program according to claim 14, wherein
said master table associates the respective one of the plurality of process identification information items with the plurality of sets of one or more operation identification information items, by assigning priorities to said plurality of sets, and
said selecting step includes a step of selecting one of said plurality of sets having higher priority.

16. The non-transitory computer-readable recording medium encoded with the operation standardization program according to claim 13, wherein
said association step includes a step of, in the case where a plurality of types of application programs are installed, at the stage when each of the plurality of types of application programs is installed, associating, for the installed application program, a respective one of said plurality of types of processes determined by said application program with a set of one or more operations among said plurality of types of operations,
said process specifying step includes a step of, in response to output by said operating portion of one or more said operation identification information items, specifying the process that has been associated with the set of one or more operations specified by said output operation identification information item(s), in said association step, for said installed application program to be executed by said computer, and
said operation notification step includes a step of outputting the process identification information of said specified process to said application portion corresponding to said application program to be executed by said computer.

17. The non-transitory computer-readable recording medium encoded with the operation standardization program according to claim 13, wherein
said operation accepting portion includes a plurality of contact switches, and
said operating portion is operative, in response to detection of connection of one or more of said plurality of contact switches, to output the operation identification information item(s) corresponding respectively to the one or more contact switches the connections of which have been detected, from among said plurality of types of processes.

18. The non-transitory computer-readable recording medium encoded with the operation standardization program according to claim 13, wherein
said operation accepting portion includes
a display portion to display an image, and
a position detecting portion to detect that position on a display surface of said display portion which is designated by an operation user,
said operating portion outputs the position on said display surface detected by said position detecting portion as the operation identification information, and
the program causes said computer to further execute:
a button displaying step of displaying an image of a button on said display portion via said operating portion; and
an operation specifying step of, in response to an event that the position on said display surface indicated by the operation identification information output from said operating portion is within the image of the button displayed on said display portion, specifying an operation corresponding to the button.
